(19) United States
(12) Patent Application Publication
(10) Pub. No.: US 2023/0393068 A1
(43) Pub. Date: Dec. 7, 2023

(54) Systems and Methods Employing Carbon Dots for the Measurement of Per- And Poly-Fluoroalkyl Substances

(71) Applicant: Triad Growth Partners LLC, Greensboro, NC (US)

(72) Inventors: Alexis Wells Carpenter, Chapel Hill, NC (US); Julia Darcy, Durham, NC (US); Wesley L. Storm, Durham, NC (US)

(73) Assignee: Triad Growth Partners LLC, Greensboro, NC (US)

(21) Appl. No.: 18/328,728

(22) Filed: Jun. 3, 2023

Related U.S. Application Data
(60) Provisional application No. 63/348,773, filed on Jun. 3, 2022.

(51) Int. Cl. G01N 21/64

(52) U.S. Cl. CPC G01N 21/6428; G01N 2021/6439

(57) ABSTRACT

Disclosed herein are carbon dots and methods for capturing and detecting per- and/or polyfluoroalkyl substances (“PFASs”) in a liquid sample. One or more PFASs are integrated in the carbon dots and are capable of binding to certain PFASs in the sample. By comparing spectral parameters of the resulting carbon dots with a reference, the identity of the PFAS can be determined.

### TECHNICAL FIELD

The patent document relates to carbon dots and methods for capturing and detecting per- and/or poly-fluoroalkyl substances (“PFASs”) in a liquid sample. The carbon dots may include one or more loaded PFASs which enable the binding of certain PFASs to the carbon dots. By comparing the change in spectral parameters before and after the binding, the PFASs in the sample can be qualitatively and quantitatively determined.

### BACKGROUND

Per- and polyfluoroalkyl substances (PFAS) are a class of man-made compounds that have been used to manufacture consumer products and industrial chemicals, including, inter alia, aqueous film forming foams (AFFFs). PFAS may be used as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. PFAS are bio-accumulative in wildlife and humans because they typically remain in the body for extended periods of time. Laboratory PFAS exposure studies on animals have shown problems with growth and development, reproduction, and liver damage.

Additionally, PFAS are highly water soluble, result in large, dilute plumes, and have a low volatility. PFAS are very difficult to treat largely because they are extremely stable compounds which include carbon-fluorine bonds. Carbon-fluorine bonds are the strongest known bonds in nature and are highly resistant to breakdown.

Current PFAS detection methods include high resolution mass spectrometry (HRMS) for targeted PFAS compound analysis and combustion ion chromatography (CIC) for nontargeted analysis of total fluorine. HRMS is mostly widely used due to high accuracy, but requires expensive equipment and laborious sample preparation, leading to high per sample costs and long turn-around times. While HRMS can be placed on a trailer for “portable” measurement, it is not ideal. CIC is gaining popularity for total organic fluorine screening to inform the need for more expensive HRMS testing. However, CIC also requires expensive, specialized equipment and like HRMS is not easily portable.

There is an ongoing need in the art to detect PFAS in order to remove these harmful compounds from the environment.

### SUMMARY

The carbon dots and methods of this patent document address the need.

An aspect of this patent document provides a method of detecting one or more test per- and/or poly-fluoroalkyl substances (PFASs) in liquid phase. The method includes

(a) providing carbon dots comprising a first loaded PFAS; and
(b) mixing the carbon dots with the liquid phase.

In some embodiments, the first loaded PFAS is in a pre-determined amount. In some embodiments, the carbon dots are prepared from precursors comprising one or more compounds selected from the group consisting of L-cysteine, citric acid and/or a salt thereof, urea, polycyclic compound, aromatic hydrocarbon, dimethyl formamide, graphite, thioglycolic acid, and a biological compound. In some embodiments, the carbon dots are further functionalized with one or more functional groups selected from the group consisting of amine, carboxyls, carbonyls, epoxides.

In some embodiments, the first loaded PFAS is selected from the group consisting of perfluoroalkyl carboxylic acid, perfluoroalkyl sulfonic acid, perfluoroalkyl phosphonic acid, perfluoroalkyl phosphinic acid, perfluoroalkyl sulfonyl fluoride, perfluoroalkyl sulfonamide, perfluoroalkyl Iodide, fluorotelomer iodide, and fluorotelomer based compound. In some embodiments, the first loaded PFAS is selected from the group consisting of CₙF₂ₙ₊₁COOH, CₙF₂ₙ₊₁SO₃H, CₙF₂ₙ₊₁PO₃H₂, CₙF₂ₙ₊₁CₘF₂ₘ₊₁PO₂H, CₙF₂ₙ₊₁SO₂F, CₙF₂ₙ₊₁SO₂R, CₙF₂ₙ₊₁I, CₙF₂ₙ₊₁CH₂CH₂I, CₙF₂ₙ₊₁CH₂CH₂R, C₂F₅OC₂F₄OCF₂COOH, and C₆F₁₃OCF₂CF₂SO₃H, wherein n and m in each instance are independently an integer from 2 to 100, wherein R in each instance is independently NH₂, NHC₁₋₁₀alkyl, N(C₁₋₁₀alkyl)₂, or NHC₁₋₁₀alkyl-OH (e.g. NHCH₂CH₂OH).

In some embodiments, the first loaded PFAS is selected to bind to a first reference PFAS. In some embodiments, the first reference PFAS is selected from the group consisting of perfluoroalkylcarboxylic acid, perfluoroinated sulfonic acid, perfluorinated sulfonamide, perfluorinated sulfonamide ethanol, perfluorinated sulfonamidoacetic acid, fluorotelomer sulfonate, fluorinated replacement chemical and trifluoacetic acid.

In some embodiments, the carbon dots are further loaded with a second loaded PFAS, wherein the second loaded PFAS is selected to bind a second reference PFAS. In some embodiments, the carbon dots comprise or consist of two or more subsets of carbon dots, wherein at least some of the first loaded PFAS and at least some of the second loaded PFAS are disposed on a same subset of the two or more subsets.

In some embodiments, the carbon dots comprise two or more subsets, and wherein the first loaded PFAS and the second loaded PFAS are disposed on different subsets of the two or more subsets. In some embodiments, the method further includes adding to the liquid phase a supplemental set of carbon dots comprising a third loaded PFAS which is selected to bind to a third reference PFAS.

In some embodiments, the method further includes, prior to step (b), enriching the one or more test PFASs. In some embodiments, the method further includes measuring one or more spectra parameters of the carbon dots. In some embodiments, the one or more spectra parameters are selected from the group consisting of excitation wavelength, emission wavelength, peak shape, and emission intensity. In some embodiments, the method further includes determining change in the emission intensity at a predetermined excitation wavelength before and/or after step (b). In some embodiments, the method further includes determining the ratio of the emission intensity of the carbon dots generated by a first predetermined excitation wavelength at two predetermined emission wavelengths.

In some embodiments, the method further includes changing the concentration of the one or more test PFASs in the liquid phase and determining the change in the emission intensity of the carbon dots at a predetermined excitation wavelength or obtained at a predetermined emission wavelength.

In some embodiments, the method further includes comparing the one or more spectra parameters with a reference.

Another aspect of this patent document discloses a carbon dot or a set of carbon dots for detecting one or more test per- and/or poly-fluoroalkyl substances, which is loaded with at least a first loaded PFAS, wherein the first loaded PFAS is predetermined or selected to bind to a first reference PFAS.

Another aspect of this patent document discloses a system or a kit for detecting one or more tested per- and/or poly-fluoroalkyl substances (PFASs) in a liquid phase, comprising one or more sets of carbon dots, wherein each of the one or more sets of carbon dots is loaded with at least a loaded PFAS which is predetermined or selected to bind to a reference PFAS.

### DETAILED DESCRIPTION

Various embodiments of this patent document disclose modified carbon dots for detection of per- and/or poly-fluoroalkyl substances (“PFAS”). Multiple populations of carbon dots, each having different binding ligands, can be employed simultaneously to detect several different species of PFAS in the same test article. Detection of PFAS binding to carbon dots can be quantified using an instrument for measuring fluorescence, such as a fluorometer.

While the following text may reference or exemplify specific embodiments of carbon dots or a method of detecting PFAS, it is not intended to limit the scope of the carbon dots or method to such particular reference or examples. Various modifications may be made by those skilled in the art, in view of practical and economic considerations, such as the configurations or ligands of the carbon dots and the concentrations or combinations of the carbon dots for PFAS detection.

The articles “a” and “an” as used herein refers to “one or more” or “at least one,” unless otherwise indicated. That is, reference to any element or component of an embodiment by the indefinite article “a” or “an” does not exclude the possibility that more than one element or component is present.

The term “about” as used herein refers to the referenced numeric indication plus or minus 10%, or plus or minus 5% of that referenced numeric indication.

The terms “comprising,” “having,” “including,” and “containing” are to be construed as open-ended terms (i.e., meaning “including, but not limited to,”) unless otherwise noted.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into and clearly implied as being presented within the specification as if it were individually recited herein. For example, if a range of 1 to 10 is described, even implicitly, unless otherwise stated, that range necessarily includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc., even if those specific values or specific sub-ranges are not explicitly stated.

The term “alkyl” refers to monovalent saturated alkane radical groups particularly having up to 10, up to 20, up to 30, or more carbon atoms, more particularly as a lower alkyl, from 1 to 20 carbon atoms and still more particularly, from 1 to 10 carbon atoms. The hydrocarbon chain may be either straight-chained or branched. The term “C₁₋₃₀ alkyl” or “C1-C30 alkyl” refers to alkyl groups having 1, 2, 3, 4, 5, 6, 7, 8, 9 or 10 carbon atoms. Similarly, the term “C₁₋₄alkyl” refers to alkyl groups having 1, 2, 3, or 4 carbon atoms. Non-limiting examples of alkyls include groups such as methyl, ethyl, n-propyl, isopropyl, n-butyl, iso-butyl, tert-butyl, n-hexyl, n-octyl, tert-octyl and the like.

The term “PFAS” refers to per- and polyfluoroalkyl substance. In a perfluoroalkyl substance, all hydrogen atoms in the alkyl chain have been replaced by fluorine atoms. In a polyfluoroalkyl substance, two or more hydrogen atoms in the alkyl chain have been replaced by fluorine atoms.

The term “carbon dots” is used to broadly refer to particles substantially comprising a carbon-based material having a particle size, for example, about or less than 10 nm. Illustrative examples of carbon-based materials include, but are not limited to, amorphous carbon, semi-crystalline carbon, crystalline carbon, graphitic carbon, graphene-like carbon, carbogenic compounds, and carbogenic oligomers. It will be understood that the carbon-based material may be doped or enriched with heteroatoms, such as N, B, S, F, O, P, Si and so forth, by using a carbogenic precursor material which contains said heteroatoms. “Naked carbon dots” as used herein refers to those without any PFAS loaded or attached. Similarly, “reference naked carbon dots” are the same as the carbon dots pre-loaded with known PFAS, except for lacking the pre-loaded known PFAS.

The term “spectroscopy” refers to information regarding how light or energy interacts with a matter or substance and thus characterizes the composition and/or properties of the matter or substance. The spectroscopy of a matter or substance includes one or more spectral parameters. Nonlimiting examples of spectroscopy include optical spectroscopy, X-ray spectroscopy, Electron spectroscopy, and Raman spectroscopy. Optical spectroscopy is based on the interaction of visible, ultraviolet (UV), and infrared (IR) light with matter and includes techniques such as absorption spectroscopy, emission spectroscopy, and fluorescence spectroscopy.

Recitation of ranges of values herein are merely intended to serve as a shorthand method of referring individually to each separate value falling within the range, unless otherwise indicated herein, and each separate value and each separate subrange defined by such separate values is incorporated into and clearly implied as being presented within the specification as if it were individually recited herein. For example, if a range of “1 to 20” reference PFAS on carbon dots or a range of “1 to 20” subgroups of carbon dots is described, even implicitly, unless otherwise stated, that range necessarily includes all values therebetween, such as for example, 1, 2, 3, 4, 5, 6, 7, 8, 9, 10, 11, 12, 13, 14, 15, 16, 17, 18, 19, 20, and includes all subranges therebetween, such as for example, 1 to 5, 2 to 10, 10-20, etc., even if those specific values or specific sub-ranges are not explicitly stated.

Carbon Dots

Carbon dots are a class of carbon-based nanoparticles that comprise discrete carbogenic nanoparticles (e.g. about 10 nm or below in size). Nonlimiting examples of carbon dots include graphene quantum dots, carbon quantum dots and carbonized polmer dots.

Carbon dots have emerged as versatile fluorescent nanoparticles possessing unique features such as high quantum yields, nontoxicity, nonblinking, high photostability and vast accessibility, with strong potential to be applied in bioimaging, sensing and optoelectronic devices. Carbon dots can be synthesized through a number of methods including laser ablation, electrochemical exfoliation, carrier-supported aqueous route, combustion route, hot injection, hydrothermal treatment, microwave treatment, and so forth. These methods generally result in hydrophilic Carbon dots with abundant —COOH and —OH groups on the surface of the Carbon dots, which are amenable for further functionalization. In functionalized carbon dots, the surface is bonded to one or more functionalization agents via primary or secondary bonding interactions with terminal functional groups on the surface of the carbon nanoparticle. The one or more functionalization agents may be, for example, a long chain organic compound having functional groups and/or moieties capable of forming primary bonding and/or secondary bonding interactions with terminal groups on the surface of the carbon nanoparticle. In general, such functional groups and/or moieties are located at or proximal to a terminal end of the long chain organic compound to facilitate formation of primary or secondary bonding interactions with terminal groups on the surface of the carbon nanoparticle. In this way, the functionalization agents become “anchored” or bound to the surface of the carbon nanoparticle. Methods of preparation and modification of carbon dots include those disclosed in U.S. Pat. Nos. 9,715,036, 10,502,686, the entire disclosure of which is hereby incorporated by reference.

An aspect of this patent document provides carbon dots loaded with one or more PFASs. Depending on the specific preparation procedures and the precursors, the PFAS may be loaded to the outside surface and/or the inside of the carbon dots.

The PFAS loaded to the carbon dots serve as a ligand for capturing PFAS in a sample. The amount or concentration of the PFAS can be adjusted in order to meet the needs of detecting one or more test or unknown PFASs in a sample. In some embodiments, the carbon dots contain one or more PFASs loaded as reference ligands, each of the PFAS ligands independently ranging from about 0.1% to about 90%, from about 1% to about 90%, from about 2% to about 90%, from about 5% to about 90%, from about 0.1% to about 50%, from about 1% to about 30%, from about 1% to about 20%, from about 1% to about 15%, from about 1% to about 10%, from about 2% to about 10%, from about 2% to about 8%, or from about 4% to about 6% w/w in the total weight of the PFAS-loaded carbon dots. Nonlimiting examples for the amount of each individual PFAS in the PFAS-loaded carbon dots include about 0.5%, about 1%, about 2%, about 4%, about 5%, about 8%, about 10%, about 15%, about 20%, about 25%, about 30%, about 35%, about 40%, about 45%, about 50%, about 60%, about 70%, about 80%, about 90%, and any range between any two of the above disclosed values.

A loaded PFAS is a known PFAS which has a clearly defined structure and is integrated in the carbon dots. Without being limited to any particular theory, it is postulated that the loaded PFAS is integrated to the carbon dots via covalent bonding (e.g. amide, sulfonamide), ionic bonding/interaction (e.g. interaction between NH2 surface group and the acid group of PFAS), hydrogen bonding, Van der Waals forces, or any combination of these. In some embodiments, the loaded PFAS is bonded via formation of covalent bonds or ionic bonds to the carbon dots due to electrons being shared and/or exchanged. In some embodiments, at least some of the loaded PFAS is distributed on the surface of the carbon dots.

A reference PFAS is also a known PFAS with a defined structure and binds to a loaded PFAS. The reference PFAS and the loaded PFAS may have the same, similar (e.g. similar carbon chain length) or different structures. Generally, each individual PFAS loaded to the carbon dots is predetermined to bind to a PFAS, which serves as a reference or standard for comparison with unknown PFAS in a sample. The binding force between the reference PFAS and the loaded PFAS includes Van der Waals forces (e.g. between C-F and C-F) and/or chemical bonding/interaction (e.g. charged groups of reference PFAS with oppositely charged group on the surface of the carbon dots, hydrogen bonding, covalent bonding), which allow the capture of the reference PFAS by the carbon dots with the loaded PFAS. A reference or standard spectral profile can thus be established for the reference PFAS when it is bound to the carbon dots with the loaded PFAS. If a test PFAS in a liquid sample exhibits the same spectra profile as the established spectra profile of the reference PFAS, it is then reasonably concluded that the test PFAS has the same identity or structure as the reference PFAS.

In some embodiments, the carbon dots collectively contain 1-50, 1-30, 1-20, or 1-10 loaded PFASs (e.g. a first loaded PFAS, a second loaded PFAS, a third loaded PFAS, a fourth loaded PFAS, or more loaded PFAS), each of which binds to a known PFAS (e.g. a first reference PFAS, a second reference PFAS, a third reference PFAS, a fourth reference PFAS, or more reference PFAS, respectively) in order to detect one, two or more PFASs in a sample to be tested.

The one or more loaded PFAS can be distributed on the same or different subsets of carbon dots. Each subset may be preloaded with a set of PFAS (e.g. 1-5 or 1-10 PFAS). In some embodiments, different sets of loaded PFAS are distributed on different subsets of carbon dots. The subsets can be physically separate and mixed together when needed. A sample to be tested can be divided into multiple portions, each of which is tested against a subset of the carbon dots. In some embodiments, at least some of the different loaded PFAS are distributed on the same subset of the carbon dots. For example, at least a portion of the first loaded PFAS and at least a portion of the second loaded PFAS can be disposed on a same subset of two or more subsets, and the remaining portions of the first loaded PFAS and the the second loaded PFAS may be distributed on the same or different subsets of carbon dots. If a third loaded PFAS is available, it can be disposed in a separate subset of its own and/or a same set with the first and/or second loaded PFAS. The different subsets can be used for detection purpose separately, sequentially or in a mixture. For example, different subsets can be separately and/or independently used for detection. They can also be added sequentially to a liquid sample. Alternatively, they can be mixed before adding a liquid sample. In some embodiments, all of the different loaded PFASs are distributed on the same set of carbon dots.

Various polymer or non-polymer PFASs can be incorporated to the carbon dots (loaded PFAS) or serve as a reference PFAS. Non-polymer PFASs include perfluoroalkyl acid (e.g. perfluoroalkyl carboxylic acid (PFCA, CₙF₂ₙ₊₁COOH), perfluoroalkyl sulfonic acid (PFSA, CₙF₂ₙ₊₁SO₃H), perfluoroalkyl phosphonic acid (PFPA, CₙF₂ₙ₊₁PO₃H₂), perfluoroalkyl phosphinic acid (PFPiA, CₙF₂ₙ₊₁CₘF₂ₘ₊₁PO₂H)), perfluoroalkyl sulfonyl fluoride (PASF, CₙF₂ₙ₊₁SO₂F), PASF based compounds (PASF, CₙF₂ₙ₊₁SO₂R, R is NH, NHCH2CH2OH, etc), perfluoroalkyl Iodide (PFAI, CₙF₂ₙ₊₁I), fluorotelomer iodide (FTI, CₙF₂ₙ₊₁CH₂CH₂I), fluorotelomer based compound (CₙF₂ₙ₊₁CH₂CH₂R, R is NH, NHCH₂CH₂OH, etc), per- and polyfluoroether carboxylic acid (PFECA, C₂F₅OC₂F₄OCF₂COOH), polyfluoroether sulfonic acid (PFESA, C₆F₁₃OCF₂CF₂SO₃H). Polymer PFASs include fluroropolymer (FP: polytetrafluorotheylene, polyvinylidene fluroride, fluorinated ethylene propylene, perfluoroalkoxyl polymer, polyvinyl fluoride, etc). side chain fluorinated polymer (fluorinated (meth)acrylated polymer, fluorinated urethane polymer, fluorinated oxetane polymer, etc), perfluoropolyether (PFPE: e.g. HOCH₂O(CₘF₂ₘO)ₙCH₂OH). m and n in each instance is an integer from 1 to 10, from 1 to 20, from 1 to 30, or greater than 30. In some embodiments, the PFAS contain 2, 3, 4, 5, 6, 7, 8, 9, 10, 11, 12, 13, 14, 15, 16, 17, 18, 19, 20 carbons or any range between any two of the foregoing disclosed values.

Further examples of PFAS that can be integrated into carbon dots include perfluoroalkylcarboxylic acids, perfluoroinated sulfonic acids, perfluorinated sulfonamides, perfluorinated sulfonamide ethanols, perfluorinated sulfonamidoacetic acid, fluorotelomer sulfonates, fluorinated replacement chemicals. Perfluoroalkylcarboxylic acids include for example perfluorobutanoic acid, perfluoropentanoic acid, perfluorohexanoic acid, perfluoroheptanoic acid, perfluorooctanoic acid, perfluorononanoic acid, perfluorodecanoic acid, perfluoroundecanoic acid, perfluorododecanoic acid, perfluorotridecanoic acid, perfluorotetradecanoic acid, perfluoro-n-hexadecanoic acid, perfluoro-n-octadecanoic acid. Perfluorofinated sulfonic acids include for example perfluoro-1-butanesulfonic acid, perfluoro-1-pentanesulfonic acid, perfluoro-1 -hexanesulfonic acid, perfluoro-1-heptanesulfonic acid, perfluoro-1-octanesulfonic acid, perfluoro-1-nonanesulfonic acid, perfluoro-1-decanesulfonic acid, perfluorododecane sulfonate. Perfluorinated sulfonamides include for example perfluoro-1-octanesulfonamide, N-methylperfluorooctanesulfonamide, N-ethylperfluorooctanesulfonamide. Perfluorinated sulfonamide ethanols include for example 2-(N-methyl perfluoro-1-octanesulfonamido)-ethanol, 2-(N-ethylperfluoro-l-octanesulfonamido)-ethanol. Perfluorinated sulfonamidoacetic acid include for example N-methyl perfluorooctanesulfonamidoacetic acid, N-ethyl perfluorooctanesulfonamidoacetic acid. Fluorotelomer sulfonates include for example 1H, 1H, 2H, 2H-perfluorohexane sulfonic acid, 1H, 1H, 2H, 2H-perfluorooctane sulfonic acid, 1H, 1H, 2H, 2H-perfluorodecane sulfonic acid, 1H, 1H, 2H, 2H-perfluorododecane sulfonate (10:2). Fluorinated replacement chemicals include for example 4,8-dioxa-3h-perfluorononanoic acid, hexafluoropropylene oxide dimer acid, 9-chlorohexadecafluoro-3-oxanonane-1-sulfonic acid, 11-chloroeicosafluoro-3-oxaundecane-1-sulfonic acid or 11-chloroeicosafluoro-3-oxaundecane-1-sulfonate. Further nonlimiting examples include nonafluoro-3,6-dioxaheptanoic acid, perfluoro(2-ethoxyethane)sulfonic acid, sodium perfluoro-1-dodecanesulfonate, perfluoro-4-methoxybutanoic acid, perfluoro-3-methoxypropanoic acid, decafluoro-4-(pentafluoroethyl)cyclohexanesulfonate), 2H-perfluoro-2-decenoic acid, 2-perfluorodecyl ethanoic acid, 2-perfluorooctyl ethanoic acid, 2H-perfluoro-2-octenoic acid, 2-perfluorohexyl ethanoic acid, fluorotelomer carboxylic acid (e.g. 3:3), fluorotelomer carboxylic acid (e.g. 5:3), fluorotelomer carboxylic acid (e,g, 7:3) or 3-perfluoropheptyl propanoic acid.

The above disclosed PFASs are not only suitable for incorporation into carbon dots as loaded PFASs, they can also service as reference PFASs which bind to certain loaded PFASs of the carbon dots.

The carbon dots are prepared from one or more compounds selected from L-cysteine, citric acid, citrate, urea, polycyclic (polycycloalkyl or polyheterocyclic) compound, aromatic hydrocarbon, dimethyl formamide, graphite, acid and/or a salt thereof, urea, polycyclic, aromatic hydrocarbons, dimethyl formamide, graphite, thioglycolic acid, and a biological component (e.g. collagen, chitin, gelatin, and sodium alginate). General procedures for carbon dots are readily available in literature, including CN104987862, US20220161234, CN103923647, CN108786857, US20220325172. The entire disclosure of these references are hereby incorporated by reference.

Further non limiting examples of precursors for carbon dots preparation include carbon-rich reagents, nitrogen containing reagents, phosphorus containing reagents, sulfur containing reagents, boron containing reagents, and biomass derived carbon reagents. Carbon-rich reagents include for example citrate, citric acid, succinic acid, amino acids, glycerol, vitamin-based small organics (e.g. vitamin C and K), polycyclic carbons (e.g. sugars such as glucose, fructose, etc.), polycyclic aromatic hydrocarbons (e.g. naphthalene, anthracene, tetracene, pyrene, benzo(a)anthracene, benzo(c)phenanthrene, triphenylene, phenanthrene, chrysene, coronene, ovalene), graphene, carbon nanotubes, microcrystalline cellulose, nanocellulose. Nitrogen containing reagents include for example urea, ethylene diamine, B vitamins, amino acids, triethanolamine, melamine, hydrazines, di-methylhydrazine, phenylhydrazine, caffeine, polyethyleneimine. Phosphorus containing reagents include for example phosphorus pentoxide, phosphoric acid, triethyl phosphonoacetate. Sulfur containing reagents include for example glutathione, sodium thiosulfate, thioglycolic acid, thiourea. Boron containing reagents include for example 4-hydroxy phenylboronic acid, and those disclosed in U.S. Pat. No. 10,280,737, the entire disclosure of which is hereby incorporated by reference. Biomass derived carbon reagents include for example fruit (peels or rinds, juice, pulp), vegetables (influorescence, stem, leaf, bud, tuber, root), seeds (nuts, husks, shell), flowers (petals, bud, pistil, stamen, sepal, receptacle), animal wastes (manure, urine, hair, crustacean shells), animal milk, animal eggs (shell, shell membrane, yolk, albumen).

The addition of one or more PFASs during the preparation process allows the resulting carbon dots to qualitatively and quantitatively bind and thus detect one or more test PFASs in a sample. In some embodiments, the compounds for the preparation of the carbon dots include one or both of citric acid and urea. In some embodiments, each individual compound for the preparation of the carbon dots independently ranges from about 1% to about 80%, from about 5% to about 80%, from about 10% to about 80%, from about 20% to about 70%, from about 30% to about 70%, from about 40% to about 60%, or from about 45% to about 55% by weight in the resulting carbon dots or in the mixture of the starting materials (excluding the solvent). Nonlimiting examples for the amount of each individual compound in the resulting carbon dots or the starting materials include about 5%, about 10%, about 15%, about 20%, about 25%, about 30%, about 40%, about 50%, about 60%, and about 70%, w/w.

The carbon dots may also be functionalized with one or more functional groups including amine, carboxylic acid or salt thereof, carbonyl (ketone or aldehyde group), and epoxides. The carbon dots may also be modified via reaction with polymers (e.g., polyethylene glycol or polyethylene imine), carbohydrates, and/or proteins. General procedures for modification of carbon dots are available in literature, including U.S. Pat. Nos. 10,745,569, 9,919,927, 9,919,927, and CN104789208. The entire disclosure of these references are hereby incorporated by reference.

The carbon dots disclosed herein can be incorporated into a solid phase. For example, after the carbon dots are loaded to a solid phase microstructure, a mostly aqueous test article containing the PFAS species to be detected or measured passing through the solid phase microstructure becomes concentrated in the interstitial space of the microstructure via Van der Waals and/or ionic binding to the PFAS-selective Carbon Dots. In some embodiments, PFAS captured by the solid-phase microstructure can be imaged directly using a microscopic technique such as fluorescence microscopy and hyperspectral imaging. In hyperspectral imaging, emission and/or excitation data can be collected from the microstructure in a 2-dimensional spatial array. The excitation wavelength and/or excitation intensity can be used to quantify PFAS trapped within the microstructure. Using a collector resin in this manner can improve the limit of detection by concentrating PFAS into a smaller volume. Other suitable solid phase for incorporating the carbon dots include film, resin, trap, filter, membrane and fibers. Alternatively, the collector resin or device is from the carbon dots and serves only for PFAS enrichment purpose.

Methods for Preparing Carbon Dots Loaded with PFAS

Another aspect of the patent document provides a method of preparing the carbon dots disclosed herein. In general, the method includes mixing one or more precursor agents and one or more PFASs in a liquid phase (aqueous or organic, solution or suspension). The scope of the precursors and the PFASs are as disclosed above. In some embodiments, the precursors are selected from L-cysteine, citric acid, citrate, urea, polycyclic (polycycloalkyl or polyheterocyclic) compound, aromatic hydrocarbon, dimethyl formamide, graphite, acid and/or a salt thereof, urea, polycyclic, aromatic hydrocarbons, dimethyl formamide, graphite, thioglycolic acid, and a biological component (e.g. collagen, chitin, gelatin, and sodium alginate). In some embodiments, the liquid phase is aqueous. In some embodiments, the liquid phase is a solution or suspension of organic solvent, which may contain water. Nonlimiting examples of the organic solvent include ethyl acetate, DMSO, methanol, ethanol, DMF, chloroform, acetone, acetic acid, and any combination thereof. The mixture is then heated with conventional heating source or microwave. In some embodiments, the mixture is heated with microwave to about 80° C., about 90° C., about 100° C., about 110° C., about 120° C., about 130° C., about 140° C., about 150° C., about 160° C., about 170° C., about 180° C., about 190° C., or about 200° C. The reaction time may range from a few minutes to 24 hours or longer. In some embodiments, the mixture is heated for 3, 5, 10, 15, 20, 30 or 60 minutes. Other techniques that are known in literature and can be incorporated with the steps of the methods disclosed herein including chemical, electrochemical or physical techniques.

In some embodiments, one or more PFASs are loaded to carbon dots by mixing the one or more PFASs, sequentially or together, with the carbon dots in a solution or suspension for a sufficient period of time. If necessary, the mixture can be heated, for example with regular heating or with microwave.

Kits Comprising Carbon Dots Loaded with PFAS

A related aspect provides a kit or a system for PFAS detection. The kit may comprise one or more containers or compartments for storing one or more sets of carbon dots. The container(s) or compartments in which the components are supplied can be any conventional container that is capable of holding carbon dots, microfuge tubes, ampoules, bottles, or integral testing devices, such as fluidic devices, cartridges, lateral flow, or other similar devices. Multiple sets of carbon dots each containing one or more loaded PFASs may be included, together or physically separate, in the kit. In some embodiments, the kit contain several compartments, each storing a different set of carbon dots with a different set of loaded PFAS.

In some embodiments, the kit can further include instructions to use the carbon dots described herein, e.g., incorporation of additional sets of carbon dots with loaded PFAS and detection of unknown PFAS in a sample. A kit, in addition to containing kit components, may further include instrumentation for detecting a signal from the carbon dots before and/or after capturing unknown PFAS in a smaple. The detector may be any suitable fluorescence detector as will be known to the skilled person. In one embodiment, the fluorescence detector is capable of detecting one or more emission wavelengths in the UV-visible spectrum. Illustrative examples of suitable fluorescence detectors include, but are not limited to, a CCD camera, a photon multiplier, an opto-electric signal converter or hyperspectral imaging device.

Optionally, the kit or system further includes software to expedite the generation, analysis and/or storage of data, and to facilitate access to databases. The kit may comprise a software package for data analysis of the physiological status of a subject to be treated, which may include reference spectral parameters (e.g. excitation wavelength, emission wavelength, peak shape, and/or emission intensity at various excitation wavelengths and/or emission wavelengths) for an individual PFAS or a mixture of PFAS at various concentrations. The software includes logical instructions or suitable computer programs that can be used in the collection, storage and/or analysis of the data. Comparative and relational analysis of the data is possible using the software provided.

A device for enriching PFASs can be included in the kit. The device collects PFASs from a sample with for example, a film, a resin, a trap or any suitable solid phase, which captures the PFASs and then releases them in a new liquid phase after being eluted with a solvent or an ionic system. The new liquid phase can be optionally concentrated before mixing with the carbon dots for PFAS detection.

The kit can also include packaging materials for holding the container or combination of containers. Typical packaging materials for such kits and systems include solid matrices (e.g., glass, plastic, paper, foil, micro-particles and the like) that hold the reaction components or detection probes in any of a variety of configurations (e.g., in a vial, microtiter plate well, microarray, and the like).

Methods for Detecting PFAS

Another aspect of this patent document provides a method for detecting one or more PFASs in a liquid phase. The method includes mixing the carbon dots disclosed herein with the liquid phase so that the one or more to-be-tested unknown PFAS (test PFAS) are bound to the carbon dots. In some embodiments, the carbon dots include at least a loaded PFAS, which has been predetermined to bind to a reference PFAS. The reference PFAS has a predetermined spectral profile after its binding to the loaded PFAS of the carbon dots. Any known PFAS, when serving as a reference PFAS, is associated with a characteristic spectra profile based on its binding to the carbon dots. A database for all known PFAS can thus be established and provides a reference or standard for comparison with unknown PFAS in a sample. The scope of the reference PFAS includes nonlimiting examples disclosed above.

A test PFAS refers to an unknown PFAS (in a liquid sample) whose chemical identity, quantity and/or concentration is to be determined. The spectra profile (e.g. excitation or emission wavelengths, peak shape, etc.) of the test PFAS is readily determined after its binding to a loaded PFAS of the carbon dots. If the spectra profile of the test PFAS matches that of a reference PFAS, they are of the same identity. The scope of the test PFAS includes nonlimiting examples of PFAS disclosed above.

In some embodiments, the reference PFAS and the test PFAS are independently selected from perfluoroalkylcarboxylic acids, perfluoroinated sulfonic acids, perfluorinated sulfonamides, perfluorinated sulfonamide ethanols, perfluorinated sulfonamidoacetic acid, fluorotelomer sulfonates, fluorinated replacement chemicals. Further, a spectral profile for trifluoracetic acid can also be obtained with methods disclosed herein and used a reference or standard for detecting trifluoracetic acid in a sample.

The carbon dots may include two or more subsets, wherein each of the subsets is integrated with a loaded PFAS for binding a particular PFAS. Different loaded PFASs can be incorporated onto different subsets of carbon dots. However, a subset may be also loaded with two or more different subsets of loaded PFASs. As a result, one or more unknown PFAS in a test sample can be detected with one or more subsets of carbon dots. Multiple subsets of the carbon dots can be added sequentially or together into the liquid phase. If necessary, an additional subset of carbon dots can be added to detect additional unknown PFAS.

A test sample may also be divided into multiple portions, each of which is tested with a subset of carbon dots with a particular loaded PFAS. Whenever multiple subsets of carbon dots are used, alone or in combination, together or separately, the different loaded PFASs of the multiple subsets can be labeled as a first loaded PFAS, a second loaded PFAS, a third loaded PFAS, a fourth loaded PFAS, etc.

One or more spectral parameters of the carbon dots, after the capture of the unknown PFAS from a sample, are obtained and then compared with one or more reference parameters so that the identity and quantity of the unknown PFAS can be determined. For instance, at one or more predetermined excitation wavelengths, the emission intensity (or change in emission intensity) and/or peak shape of the carbon dots at one or more emission wavelengths are collected after the capture of the unknown PFAS. These data are then compared with reference spectral data associated with known PFASs in a database, optionally at various concentrations.

Regarding reference or standard spectral parameters, a database is readily prepared based on the emission spectra evaluation of naked carbon dots and/or carbon dots loaded with one, two, three, or more known PFASs. The database may include one or more of the following references (e.g. emission intensity, excitation or emission wavelengths, peak shape) and additional references (e.g. change in intensity, ratio of emission intensity at two or more emission wavelengths) derived from them.
A. emission intensity, at one or more predetermined excitation wavelengths and predetermined emission wavelengths, of naked carbon dots, which do not have any loaded PFAS;
B. (1) emission intensity, at one or more predetermined excitation wavelengths and predetermined emission wavelengths, after a single known PFAS (at various concentration and/or in various solvents) is loaded to the naked carbon dots; (2) change in emission intensity between PFAS bound carbon dots in B and naked carbon dots in A;
C. (1) the emission intensity, at one or more predetermined excitation wavelengths and predetermined emission wavelengths, after a known PFAS, at various concentrations and/or in various solvents or suspensions, binds to the loaded PFAS of the carbon dots in B; (2) change in emission intensity of the carbon dots between before and after the known PFAS binds to the loaded PFAS; the data is C(1) and C(2) then serves as a reference or standard with the known PFAS (reference PFAS);
D. ratio in emission intensity, at two or more predetermined emission wavelengths and one or more predetermined excitation wavelengths, after a known PFAS (at various concentrations) binds to the loaded PFAS of the carbon dots in B;
E. For B, C, and D above, the carbon dots may have two or more loaded PFASs; the carbon dots may also have different subsets, which are mixed together or separate from each other.

The spectral parameters of various polymer or non-polymer PFASs can be measured according to the procedures described herein. The scope of the polymer or non-polymer PFASs is as described above. The spectral measurement can be in solution or suspension or could be on the carbon dots isolated from solution or suspension (e.g. using a lateral flow kit).

Nonlimiting examples of PFASs that can be characterized and used for detection reference include perfluoroctanesulfonic acid, perfluorononaoic acid, perfluorohexanoic acid, perfluorohexanesulphonic acid, perfluoroheptanoic acid, and perfluoroheptanesulfonic acid. Additional literature on PFAS include U.S. Pat. Nos. 11,512,012, 11,512,146, and 11,027,988, the entire disclosure of which are hereby incorporated by reference. Of course, any of these PFASs, if present in a sample, can be detected according to the methods disclosed herein.

Besides the above disclosed spectral parameters, Raman spectroscopy can also be obtained for carbon dots, with or without reference PFAS loaded thereto. Similar as described above, each PFAS, when bound to a loaded PFAS of carbon dots, has a unique fingerprint Raman spectroscopy, which can be used as a reference for the detection and quantification of PFAS. A commonly used Raman spectroscopy is vibrational Raman using laser wavelengths which are not absorbed by the sample. There are many other variations of Raman spectroscopy including surface-enhanced Raman, resonance Raman, tip-enhanced Raman, polarized Raman, stimulated Raman, transmission Raman, spatially-offset Raman, and hyper Raman.

In some embodiments, when a combination of PFAS having selectivity or affinity for each other are bound to the same carbon dots, a synergist change (greater than the sum of changes from individual PFAS) in emission intensity at one or more particular emission wavelengths and resulting from one or more particular excitation wavelengths can be observed. Meanwhile, the ratio of emission intensity at one or more particular emission wavelengths and resulting from one or more particular excitation wavelengths can be unique to the combination. The above reference spectral parameters therefore provide a fingerprint for every known PFAS, alone or in combination with a second known PFAS in various conditions (e.g. emission intensity at different predetermined excitation wavelengths and emission wavelengths) on carbon dots, which also have a predetermined composition and configuration. Other reference parameters such as peak shape of an emission at one or more predetermined excitation wavelengths and predetermined emission wavelengths, can also be collected at each of the above steps to enhance the fingerprint profile. One or more of the above reference spectra parameters can thus be used to determine the status of a test or unknown PFAS.

In some embodiments, the synergistic change (greater than the sum of changes from individual PFAS) in emission intensity, associated with a single particular emission wavelength and resulting from a single particular excitation wavelength (based on reference B and C above), is one of the characteristics of a particular combination of two or more PFAS. A different excitation wavelength may not lead to any synergistic change.

In some embodiments, the unique ratio of emission intensity, associated with two particular emission wavelengths and resulting from a single particular excitation wavelength (based on reference D above), is one of the characteristics of a particular combination of two or more PFASs. A different excitation wavelength may not produce the same ratio.

In some embodiments, the change in emission intensity or peak shape according to changing (increasing or decreasing) concentrations of one or more PFASs is one of the characteristics of a particular combination of one or more PFASs bound to the loaded PFAS of the carbon dots. When a loaded PFAS of the carbon dots binds an unknown PFAS in the liquid sample, the emission intensity will change with changing concentrations of the unknown PFAS in the sample. For example, if the emission intensity of the carbon dots decreases with increasing concentration of the unknown PFAS, by comparing the pattern with a reference (e.g. reference E above), the identity and concentration/amount of the unknown PFAS can be determined.

The spectral parameters of a to-be-tested unknown PFAS in a sample can be measured similarly and compared with the above reference parameters to determine its identity, qualitatively and quantitatively. The sample to be tested can be divided into multiple equal portions for mixing and binding to the carbon dots with a loaded reference PFAS. While each portion (e.g. first sample set, second sample set, or additional sample set) may contain the same concentrations of the one or more test PFASs, the concentrations of an individual portion can be adjusted to facilitate detection. If necessary, the test sample may be diluted, concentrated, or modified in any way to facilitate the PFAS capture and detection and minimize the impact from other components or impurities in the sample. In some embodiments, the concentration of the sample is adjusted so that about 70 parts per trillion PFAS to about 3 parts per million PFAS, about 100 parts per trillion PFAS to about 3 parts per million PFAS, about 200 parts per trillion PFAS to about 3 parts per million PFAS, about 500 parts per trillion PFAS to about 3 parts per million PFAS, about 1000 parts per trillion PFAS to about 3 parts per million PFAS and any sub-range in between the recited ranges is detected. In an example embodiment, an unknown PFAS in a test sample is mixed with carbon dots loaded with one or more PFASs in a predetermined amount, and the emission spectra (emission intensity, peak shape, excitation wavelength, emission wavelength, etc) of the carbon dots is determined. The unknown PFAS may also be bound to the loaded PFAS of the carbon dots at different concentrations and the resulting emission intensity at different wavelengths is measured. After all these information is compared with reference parameters of the database built on known PFASs, the identity and concentration of the unknown PFAS can be readily determined.

If a set or subset of carbon dots with a first loaded PFAS does not capture any unknown PFAS from a sample as indicated by spectral measurements, the detection procedure can be repeated with one or more additional set or subset of carbon dots with different loaded PFAS (e.g. a second loaded PFAS, a third loaded PFAS, a fourth loaded PFAS, a fifth loaded PFAS, etc.).

In some embodiments, the predetermined excitation wavelength ranges from about 300 to about 600 nm, from about 300 to about 500 nm, from about 320 to about 400 nm, from about 320 to about 380 nm or from about 300 to about 400 nm. Nonlimiting examples include 300 nm, 310 nm, 320 nm, 330 nm, 340 nm, 345 nm, 346 nm, 348 nm, 350 nm, 352 nm, 354 nm, 356 nm, 358 nm, 360 nm, 362 nm, 364 nm, 365 nm, 366 nm, 368 nm, 370 nm, 372 nm, 374 nm, 375 nm, 376 nm, 378 nm, 380 nm, 382 nm, 384 nm, 386 nm, 388 nm, 390 nm, 392 nm, 394 nm, 396 nm, 398 nm, 400 nm, 402 nm, 404 nm, 406 nm, 408 nm, 410 nm, 412 nm, 414 nm, 416 nm, 418 nm, 420 nm, 422 nm, 424 nm, 426 nm, 428 nm, 430 nm, 432 nm, 434 nm, 436 nm, 438 nm, 440 nm, 442 nm, 444 nm, 446 nm, 448 nm, 450 nm, 452 nm, 454 nm, 455 nm, 460 nm, 470 nm, 480 nm, 490 nm, and 500 nm.

In some embodiments, the predetermined emission wavelength range from about 300 to about 800 nm, from about 300 to about 700 nm, from about 320 to about 600 nm, from about 330 to about 550 nm or from about 300 to about 400 nm. Nonlimiting examples include 310 nm, 312 nm, 314 nm, 316 nm, 318 nm, 320 nm, 322 nm, 324 nm, 326 nm, 328 nm, 330 nm, 332 nm, 334 nm, 336 nm, 338 nm, 340 nm, 342 nm, 344 nm, 345 nm, 346 nm, 348 nm, 350 nm, 352 nm, 354 nm, 356 nm, 358 nm, 360 nm, 362 nm, 364 nm, 365 nm, 366 nm, 368 nm, 370 nm, 372 nm, 374 nm, 375 nm, 376 nm, 378 nm, 380 nm, 382 nm, 384 nm, 386 nm, 388 nm, 390 nm, 392 nm, 394 nm, 396 nm, 398 nm, 400 nm, 402 nm, 404 nm, 406 nm, 408 nm, 410 nm, 412 nm, 414 nm, 416 nm, 418 nm, 420 nm, 422 nm, 424 nm, 426 nm, 428 nm, 430 nm, 432 nm, 434 nm, 436 nm, 438 nm, 440 nm, 442 nm, 444 nm, 446 nm, 448 nm, 450 nm, 452 nm, 454 nm, 455 nm, 456 nm, 458 nm, 460 nm, 462 nm, 464 nm, 466 nm, 468 nm, 470 nm, 472 nm, 474 nm, 476 nm, 478 nm, 480 nm, 482 nm, 484 nm, 486 nm, 488 nm, 490 nm, 492 nm, 494 nm, 496 nm, 498 nm, and 500 nm.

The spectra parameter can be directly detected from the carbon dots with or without PFAS loaded. In some embodiments, the unknown PFAS in a liquid sample is captured in a solid collector substrate, for example, by passing the sample through the collector. Nonlimiting examples of the suitable solid phase include film, resin, trap, membrane and fibers. The captured PFAS is then eluted off the substrate with a solvent or ionic solution (e.g. ammonium acetate in methanol). The eluent is optionally concentrated to enrich the PFAS and is then mixed with the carbon dots disclosed herein. Spectral parameters (e.g fluorescence, peak shape, etc.) of the carbon dots are measured as described above.

In some embodiments of the carbon dots and methods of detection disclosed herein, the capturing of 1, 2, 3 or more test PFASs by the carbon dots with 1, 2, 3 or more loaded PFASs results in a decrease in fluorescence by a range of from about 2% to about 90%, from about 5% to about 80%, from about 10% to about 60%, from about 10% to about 50%, from about 20% to about 50%, or from about 30% to about 50%. Nonlimiting examples in the decrease of fluorescence resulting from the capturing of the PFAS include about 5%, about 10%, about 15%, about 20%, about 25%, about 30%, abut 40%, about 50%, about 60%, about 70%, about 80%, and any range between any two of the aforementioned values. In some embodiments, the fluorescence of the carbon dots vary by less than 1%, less than 2%, less than 3%, less than 4%, less than 5%, or less than 10% if no test PFAS binds to the loaded PFAS on the carbon dots.

In some embodiments, the carbon dots, naked or preloaded with PFAS, are used to capture PFAS in a sample. The captured PFAS can then be eluted and optionally concentrated and then characterized with known analytical methods (e.g. mass spectrometry).

The carbon dots loaded with PFAS can also be used to capture PFAS from any pollutant source or sample. The captured PFAS can then be washed off with, for example, a solvent or ionic solution to a separate container for disposal. The PFAS loaded carbon dots are regenerated after removal of the pollutant PFAS.

The liquid sample containing the unknown PFAS can be a solution, a suspension. In some embodiments, the liquid sample is an aqueous phase. Various solvents, polar or nonpolar, can be added to the liquid phase to facilitate the detection of the PFAS. If necessary, the sample can be further diluted to ensure the carbon dots can capture the PFAS in the sample.

### EXAMPLES

### Example 1

Novel carbon dots were created to attach or load perfluorooctanoic acid (PFOA) to the surface of the carbon dot in order to attract PFAS compound to the carbon dot. Carbon dots were created by adding 0.3 grams of PFOA (5% of the total weight), 3 grams of citric acid, and 3 grams of urea in 10 milliliters of deionized water, contained in a microwave reactor. The solution was mixed for 5 minutes without heat being applied and then heated to 150 Celsius for 15 minutes. Color of the solution changed from clear to a dark blue solution. Dialysis tubing was used to isolate the carbon dots from the remaining solution for 24 hours. A UV-Vis spectra was taken of the solution to determine the excitation wavelength of 345 nanometers to be used for fluorescence measurements. The fluorescence of the carbon dots was measured, then the change of fluorescence was measured through the titration of 50 ppm PFOA, 20 of microliter aliquots were added to create a final concentration of 1.6 ppm.

The titration of PFOA created a consistently decreasing change in fluorescence of the carbon dots. The PFOA that was attached to the carbon dot seems to attract the PFOA in the titration to allow for this change of fluorescence.

### Example 2

Citric acid was mixed with urea in a microwave under high pressure conditions in order to create novel carbon dots that are sensitive to PFAS compounds interacting with the surface of the carbon dot, shown through a change in fluorescence. Carbon dots were created by adding 3 grams of citric acid and 3 grams of urea in 10 milliliters of deionized water, contained in a microwave reactor. The solution was mixed for 5 minutes without heat being applied and then heated to 150 Celsius for 15 minutes. Color of the solution changed from clear to a dark blue solution. Dialysis tubing was used to isolate the carbon dots from the remaining solution for 24 hours. A UV-Vis spectra was taken of the solution to determine the excitation wavelength of 345 nanometers to be used for fluorescence measurements. The fluorescence of the carbon dots was measured, then the change of fluorescence was measured through the titration of 50 ppm perfluorooctanoic acid, 20 of 5 microliter aliquots were added to create a final concentration of 1.6 ppm.

The method creates carbon dots that fluoresce well but are not sensitive to the gradual addition of PFOA through titration. There is a sharp decrease in fluorescence with the first addition of PFOA, but it maintains a consistent fluorescence intensity throughout the continued titration. When compared to method in the example above, it can be concluded that the PFOA loaded to the carbon dot does allow a calibration curve to be created unlike carbon dots created without PFOA attached to the surface.

### Example 3

Carbon dots were synthesized using the methods that were described in the two above examples. A water titration was tested in order to determine if the change in fluorescence intensity that was recorded was due to a PFAS compound being added or a solution being added to the carbon dots. 5 microliters of water was added to the carbon dots 4 times to closely reflect the standard operating procedure of a PFOA titration with the change of fluorescence intensity recorded each time.

There was not a significant change in fluorescence with the addition of water via titration in either Example 2 carbon dots or Example 1 carbon dots. This shows that the change in fluorescence intensity in previous experiments is due to the addition of PFOA into the carbon dot solution.

### Example 4

Novel carbon dots were created to load a high concentration of perfluorooctanoic acid to the surface of the carbon dot in order to attract PFAS compound to the carbon dot. Carbon dots were created by adding 0.45 grams of perfluorooctanoic acid (13% of the total weight), 3 grams of citric acid, and 3 grams of urea in 10 milliliters of deionized water, contained in a microwave reactor. The solution was mixed for 5 minutes without heat being applied and then heated to 150 Celsius for 15 minutes. Color of the solution changed from clear to a dark blue solution. Dialysis tubing was used to isolate the carbon dots from the remaining solution for 24 hours. A UV-Vis spectra was taken of the solution to determine the excitation wavelength of 345 nanometers to be used for fluorescence measurements. The fluorescence of the carbon dots was measured, then the change of fluorescence was measured through the titration of 50 ppm perfluorooctanoic acid, 20 of 5 microliter aliquots were added to create a final concentration of 1.6 ppm.

It will be appreciated by persons skilled in the art that the present invention is not limited to what has been particularly shown and described. Rather, the scope of the present invention is defined by the claims which follow. It should further be understood that the above description is only representative of illustrative examples of embodiments. The description has not attempted to exhaustively enumerate all possible variations. The alternate embodiments may not have been presented for a specific portion of the invention, and may result from a different combination of described portions, or that other un-described alternate embodiments may be available for a portion, is not to be considered a disclaimer of those alternate embodiments. It will be appreciated that many of those un-described embodiments are within the literal scope of the following claims, and others are equivalent.

1. A method of detecting one or more test per- and/or poly-fluoroalkyl substances (PFASs) in liquid phase, comprising
(a) providing carbon dots comprising a first loaded PFAS; and
(b) mixing the carbon dots with the liquid phase.

2. The method of claim 1, wherein the first loaded PFAS is in a pre-determined amount.

3. The method of claim 1, wherein the carbon dots are prepared from precursors comprising one or more compounds selected from the group consisting of L-cysteine, citric acid and/or a salt thereof, urea, polycyclic compound, aromatic hydrocarbon, dimethyl formamide, graphite, thioglycolic acid, and a biological compound.

4. The method of claim 1, wherein the carbon dots are further functionalized with one or more functional groups selected from the group consisting of amine, carboxyl, carbonyl, and epoxide.

5. The method of claim 1, wherein the first loaded PFAS is selected from the group consisting of perfluoroalkyl carboxylic acid, perfluoroalkyl sulfonic acid, perfluoroalkyl phosphonic acid, perfluoroalkyl phosphinic acid, perfluoroalkyl sulfonyl fluoride, perfluoroalkyl sulfonamide, perfluoroalkyl iodide, fluorotelomer iodide, and fluorotelomer based compound.

6. The method of claim 1, wherein the first loaded PFAS is selected from the group consisting of CₙF₂ₙ₊₁COOH, CₙF₂ₙ₊₁SO₃H, CₙF₂ₙ₊₁PO₃H₂, CₙF₂ₙ₊₁CₘF₂ₘ₊₁PO₂H, CₙF₂ₙ₊₁SO₂F, CₙF₂ₙ₊₁SO₂R, CₙF₂ₙ₊₁I, CₙF₂ₙ₊₁CH₂CH₂I, CₙF₂ₙ₊₁CH₂CH₂R, C₂F₅OC₂F₄OCF₂COOH, and C₆F₁₃OCF₂CF₂SO₃H, wherein n and m in each instance are independently an integer from 2 to 100, wherein R in each instance is independently NH₂, NHC₁₋₁₀alkyl, N(C₁₋₁₀alkyl)₂, or NHC₁₋₁₀alkyl-OH.

7. The method of claim 1, wherein the first loaded PFAS is selected to bind to a first reference PFAS.

8. The method of claim 7, wherein the first reference PFAS is selected from the group consisting of perfluoroalkylcarboxylic acid, perfluoroinated sulfonic acid, perfluorinated sulfonamide, perfluorinated sulfonamide ethanol, perfluorinated sulfonamidoacetic acid, fluorotelomer sulfonate, fluorinated replacement chemical and trifluoacetic acid.

9. The method of claim 1, wherein the carbon dots are further loaded with a second loaded PFAS, wherein the second loaded PFAS is selected to bind a second reference PFAS.

10. The method of claim 9, wherein the carbon dots comprise two or more subsets of carbon dots, wherein at least some of the first loaded PFAS and at least some of the second loaded PFAS are disposed on a same subset of the two or more subsets.

11. The method of claim 9, wherein the carbon dots comprise two or more subsets, and wherein the first loaded PFAS and the second loaded PFAS are disposed on different subsets of the two or more subsets.

12. The method of claim 1, further comprising adding to the liquid phase a supplemental set of carbon dots comprising a third loaded PFAS which is selected to bind to a third reference PFAS.

13. The method of claim 1, further comprising, prior to step (b), enriching the one or more test PFASs.

14. The method of claim 1, further comprising measuring one or more spectra parameters of the carbon dots.

15. The method of claim 14, wherein the one or more spectra parameters are selected from the group consisting of excitation wavelength, emission wavelength, peak shape, and emission intensity.

16. The method of claim 15, comprising determining change in the emission intensity at a predetermined excitation wavelength before and/or after step (b).

17. The method of claim 15, further comprising determining the ratio of the emission intensity of the carbon dots generated by a first predetermined excitation wavelength at two predetermined emission wavelengths.

18. The method of claim 15, further comprising changing the concentration of the one or more test PFASs in the liquid phase and determining the change in the emission intensity of the carbon dots at a predetermined excitation wavelength or obtained at a predetermined emission wavelength.

19. The method of claim 14, further comprising comparing the one or more spectra parameters with a reference.

20. A carbon dot for detecting one or more test per- and/or poly-fluoroalkyl substances, which is loaded with at least a first loaded PFAS, wherein the first loaded PFAS is selected to bind to a first reference PFAS.

21. A system for detecting one or more tested per- and/or poly-fluoroalkyl substances (PFASs) in a liquid phase, comprising one or more sets of carbon dots, wherein each of the one or more sets of carbon dots is loaded with at least a loaded PFAS which binds to a reference PFAS.
